(19) United States
(12) Patent Application Publication
(10) Pub. No.: US 2026/0091905 A1
(43) Pub. Date: Apr. 2, 2026

(54) LABELING MACHINE FOR APPLYING LABELS TO REUSABLE CONTAINERS

(71) Applicant: P.E. LABELLERS S.P.A., Porto Mantovano (IT)

(72) Inventor: Riccardo BARDINI, Torri Del Benaco (IT)

(21) Appl. No.: 19/113,186

(22) PCT Filed: Sep. 6, 2023
(86) PCT No.: PCT/EP2023/074499

§ 371 Date: Mar. 19, 2025

(30) Foreign Application Priority Data
Sep. 23, 2022 (IT) 102022000019500

(51) Int. Cl. B65C 9/26; B65C 9/18

(52) U.S. Cl. CPC B65C 9/26; B65C 9/1819; B65C 2009/1861

(57) ABSTRACT

A labeling machine for applying labels to reusable containers includes at least one labeling assembly that includes a transfer drum provided peripherally with at least one sector that receives from a cutting roller a label; upstream of the labeling assembly there are spraying elements for spraying an adhesive material at least on the region of the containers that is adapted to receive the labels; the sector has at least one movable portion which can move between a first working condition, wherein the front end of the sector is arranged close to the axis of the transfer drum, and a second working condition, wherein the front end of the sector is arranged in a position that is spaced apart from the axis of the transfer drum, in order to allow the adhesion of the leading end of the label to the corresponding container.

The present invention relates to a labeling machine for applying labels to reusable containers.

It is known that, in order to limit the dispersion in the environment of plastic packaging and containers, in some countries the use of reusable containers has been made mandatory.

In this case, the labeled containers are handed in by users, after use, so that they can be subsequently stripped of their labels, washed and sterilized, so as to make them ready for re-labeling, refilling and, therefore, reuse.

Typically, labels that are applied to reusable containers are obtained from a label ribbon made of plastic material and are wound around the side surface of the corresponding container, gluing one of their ends onto the other.

In particular, labeling machines are known which make it possible to automatically affix labels on containers so that they are wound around the side surface of those containers.

Generally, these machines have a conveyor for the containers to be labeled that makes it possible to make the containers advance along an advancement path.

The conveyor for the containers is, normally, constituted by a rotating carousel, which is provided peripherally with pans for supporting the containers, which are adapted to rotate the individual containers about their respective axes.

Arranged along the advancement path of the containers defined by the conveyor and, more specifically, around the carousel, there is, furthermore, at least one labeling assembly, which usually comprises a base framework which can be stably or removably coupled to the fixed framework of the carousel and which supports, at a work region, directed toward the carousel, labeling means which make it possible to affix the labels on individual containers that arrive from the carousel.

In particular, in labeling machines that use spools of label ribbons, the labeling means normally comprise an unwinder, constituted by a pair of contra-rotating rollers, the function of which is to take the label ribbon from the corresponding spool in order to feed it to a rotating cutting roller, which cuts the single labels and subsequently feeds them to a transfer drum, which is rotated about its own axis and which makes it possible to transfer the single, cut labels to the respective containers.

In other types of labeling machines, at the exit point from the unwinder, the label ribbon is fed directly to a cutting and transfer drum, which is provided peripherally with means for cutting the label ribbon, so as to be capable of cutting the label ribbon and subsequently transferring the labels obtained after cutting to the containers that arrive from the carousel.

In general, the transfer drum, or the cutting and transfer drum, is able to receive the labels to be transferred so that they adhere to its own side surface, by virtue of the presence, on its side surface, of air intake ports, which make it possible to retain the labels until their transfer onto the containers.

Furthermore, along its perimeter, the transfer drum, or the cutting and transfer drum, is typically divided into one or more sectors or partitions, which are adapted, in each instance, to receive each a respective label to be transferred to the corresponding container carried by the carousel, and the drum has an outer side surface at the substantially cylindrical sectors with a radius of curvature that is constant and centered on the rotation axis of the drum.

It should be noted that the label ribbon can be provided with pre-applied strips of glue at the leading and trailing ends of the single labels, or it can be free from adhesive and, in such case, in the work region of the labeling assembly, in particular in a side position with respect to the transfer drum, or cutting and transfer drum, there are means for applying the glue, typically constituted by a glue roller or by elements that make it possible to spray the glue onto the labels, which apply two strips of glue at the leading and trailing ends of the single labels.

Typically, each sector of the transfer drum or of the cutting and transfer drum is provided, at its opposite circumferential ends, with two skids or pads, on which the leading and trailing ends of the single labels are respectively placed.

The skids slightly protrude with respect to the remaining part of the side surface of the corresponding sector, so as to ensure that the single label placed on the sector can come into contact with the glue roller, if any, so that it can receive two strips of glue exclusively on its leading and trailing ends.

In this manner, the labels are transferred to the containers by making their leading end adhere to the corresponding container by way of the corresponding strip of glue and, after the label has been wrapped around the container, via the rotation of the container, by making the trailing end of the label adhere, by way of the other strip of glue, to a portion of the same label on which the trailing end of the label is superimposed.

Labels applied to containers in this manner are difficult to remove.

Therefore labeling machines have been provided which make it possible to apply labels to containers by using, to make the leading end of the labels adhere to the corresponding container, a dissolvable adhesive material, which loses its adhesive characteristics after a predefined time interval which is sufficiently long to allow the application of labels to containers but not so long as to impede the easy removal of the labels, when the containers need to be recovered for reuse.

Typically, water is used as dissolvable adhesive material.

It should be noted that the presence of the glue only on the trailing end of the label requires that the application of the labels onto the containers occurs in a manner known in the jargon as “skid-to-skid”.

In particular, in these machines the transfer drum is made to rotate in the opposite direction to that of the carousel, in order to reduce the region of interference between the containers and the transfer drum, and the transfer drum is structured so as to have a double contact, in particular a contact between the front skid and the container and subsequently between the rear skid and the container.

To this end, the transfer drum in these machines has a particular shape structure, in which each sector is in a position that is misaligned with the axis of the transfer drum, with respect to the typical progression of the side surface of a traditional cylindrical transfer drum, and is contoured with a radius of curvature of its side surface that is, again, greater than a traditional cylindrical transfer drum, so as to have interference between the transfer drum and the containers at the skids but not at the part of the sector located between the two skids, as explained in more detail below.

In more detail, these labeling machines have, along the conveyor for the containers, upstream of the labeling assembly, means for spraying the containers with a jet of atomized water, so that the containers are presented wet at the labeling assembly, at least in the region in which the label will be applied.

The presence of water on the surface of the containers enables the leading end of the labels to adhere temporarily to the containers, while the trailing end of the labels is provided with a strip of glue, so as to enable its adhesion to the portion of the label on which it is superimposed.

In these machines, the label ribbon is cut by a cutting roller which transfers the single labels obtained after cutting to a corresponding sector of a transfer drum, so that the leading and trailing ends are placed on the skids of the sector that has received the label.

In this case, the leading or front skid of the sector, i.e. the skid adapted to receive the leading end of the label in resting contact, is structured to be able to pass in front of the glue roller without touching it, in order to prevent the leading end of the label from receiving glue and, at the same time, to allow the leading end of the label to adhere to the wet surface of the container, while the trailing or rear skid of the sector, on which the trailing end of the label is placed in turn, is structured to allow the trailing end of the label to receive glue from the glue roller and to ensure the correct adhesion of the trailing end of the label on the portion of said label on which it is superimposed after being wound around the container.

Also in this case, in order to ensure a correct transfer of the labels to the containers from the sectors of the transfer drum, the outer side surface of the sectors of the transfer drum are contoured so as to ensure the presence of a reduced distance between the outer side surface of the sectors and the containers to be labeled, at least along the path segment of the containers in which the transfer drum transfers the labels to those containers, while limiting the interference between the transfer drum and the container to the skids and optionally to regions adjacent thereto.

In particular, the side surface of the sectors of the transfer drum is contoured so as to extend, at least partially, on a cylindrical surface, the center of which is not arranged on the rotation axis of the transfer drum and the radius of curvature of which is greater than that of the side surface of a traditional cylindrical transfer drum, therefore being misaligned with the axis of the transfer drum with respect to the side surface of a traditional transfer drum, so that the interference between sector and container can happen only at the skids and the regions immediately adjacent thereto.

In this manner the label, during its transfer, can cover a greater angle with respect to the case where the sector had a profile that follows the typical progression of traditional transfer drums.

However, with this structuring, if the blade of the cutting roller is kept in phase with the trailing end of each label, the front part of these labels will be delayed with respect to the front skid of the corresponding sector.

It follows from this that, during the step of transfer of the labels from the cutting roller to the transfer drum, there is a period of time during which the label is not correctly guided in its movement, and so it might be arranged on the transfer drum to form bulges, with the possibility that parts of the label might come into contact with the glue roller which are not adapted to receive glue, so compromising the operation of the machine.

The aim of the present invention is to provide a labeling machine for applying labels to reusable containers which is capable of improving the known art in one or more of the above-mentioned aspects.

Within this aim, an object of the invention is to provide a labeling machine for applying labels to reusable containers that is capable of ensuring the correct application of the labels on containers by way of the use of a dissolvable adhesive material.

Another object of the invention is to provide a labeling machine for applying labels to reusable containers that makes it possible to prevent discrepancies during the transition of the labels from the cutting roller to the transfer drum.

A further object of the present invention is to overcome the drawbacks of the known art in an alternative manner to any existing solutions.

Another object of the invention is to provide a labeling machine for applying labels to reusable containers that is highly reliable, is relatively easy to implement, and can be produced at low cost.

This aim and these and other objects which will become better apparent hereinafter are achieved by a labeling machine for applying labels to reusable containers according to claim 1, optionally provided with one or more of the characteristics of the dependent claims.

Further characteristics and advantages of the invention will become better apparent from the detailed description that follows of a preferred, but not exclusive, embodiment of a labeling machine for applying labels to reusable containers according to the present invention, which is illustrated for the purposes of non-limiting example in the accompanying drawings wherein:

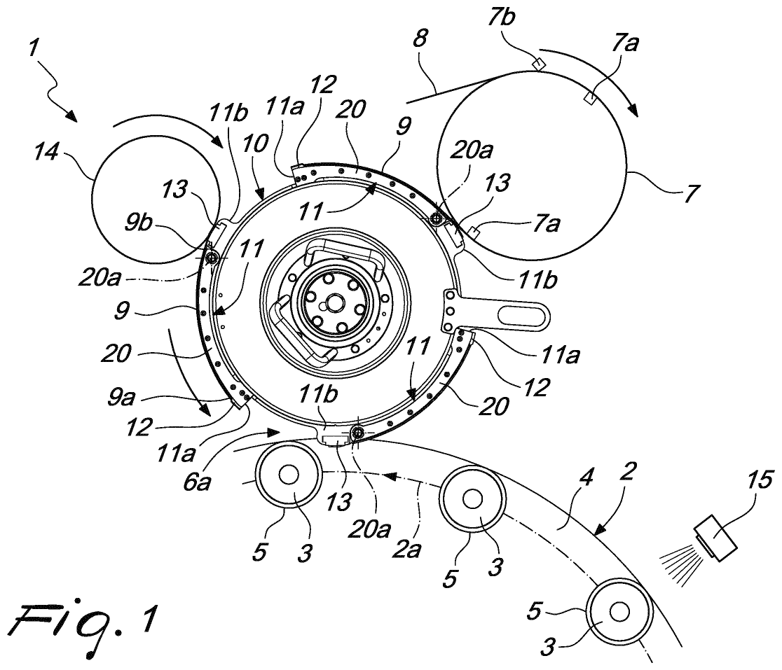

FIG. 1 is a schematic plan view from above of the machine according to the present invention;

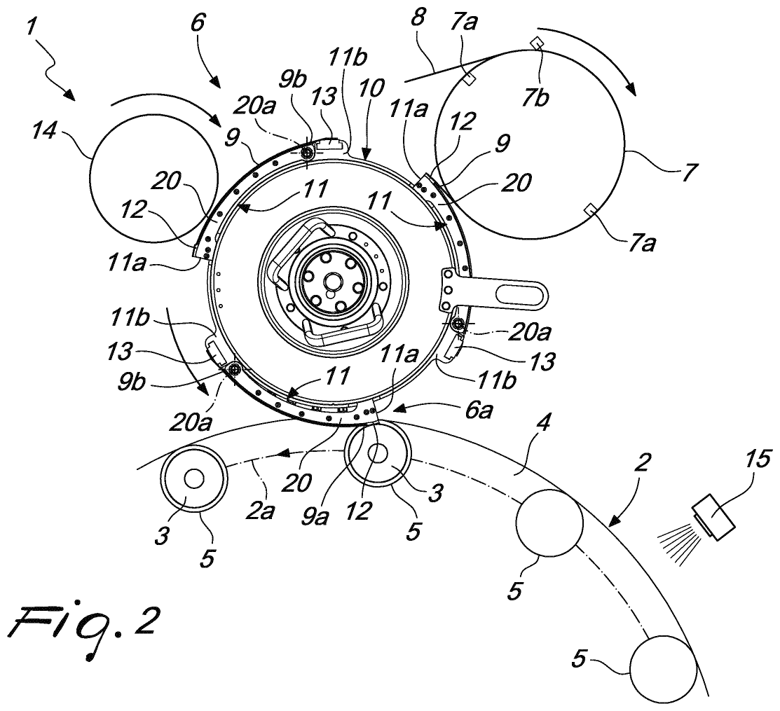

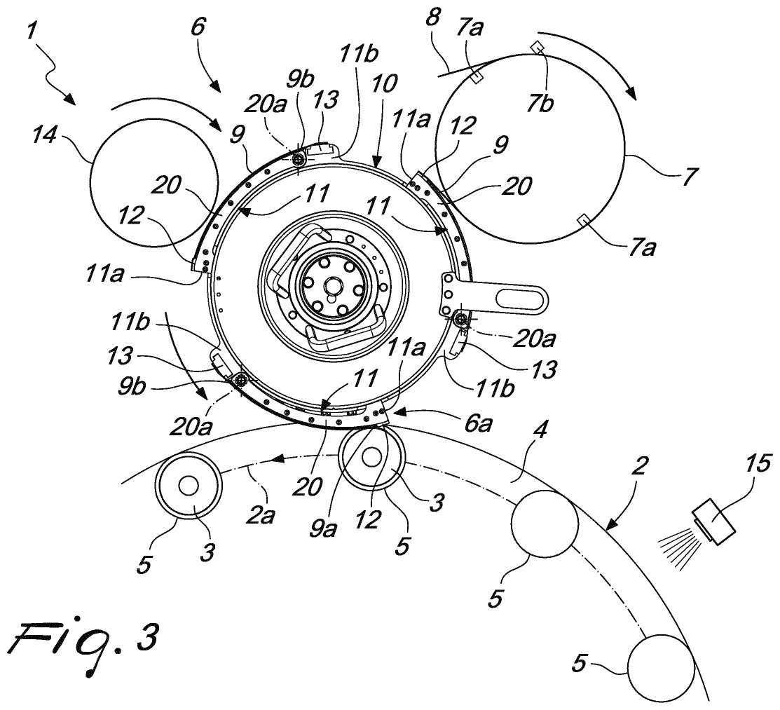

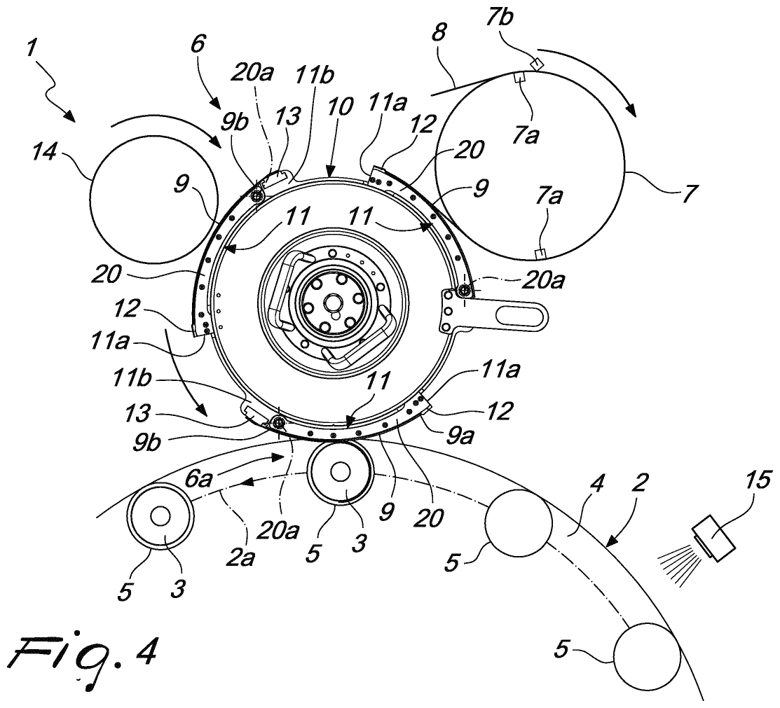

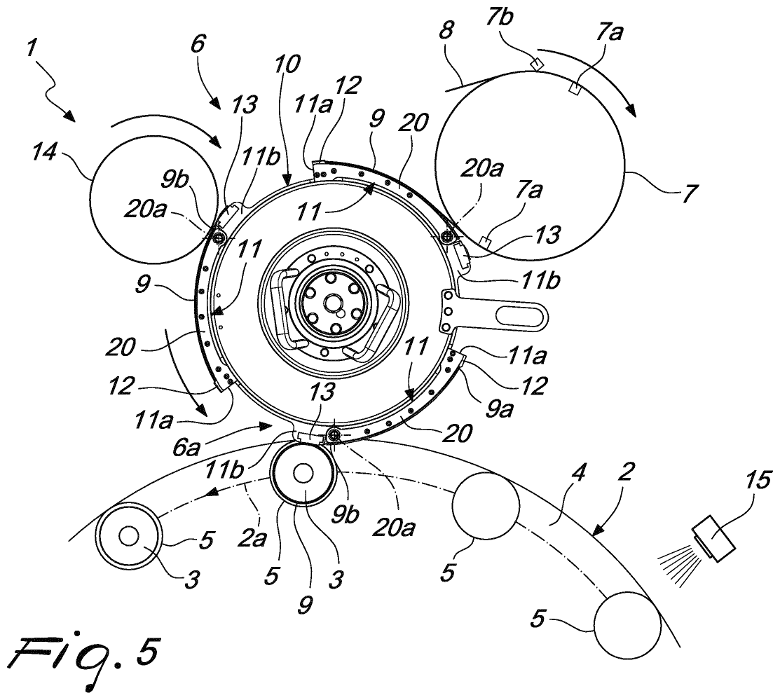

FIGS. 2 to 5 are schematic plan views from above of a sequence of steps of operation of the machine according to the present invention;

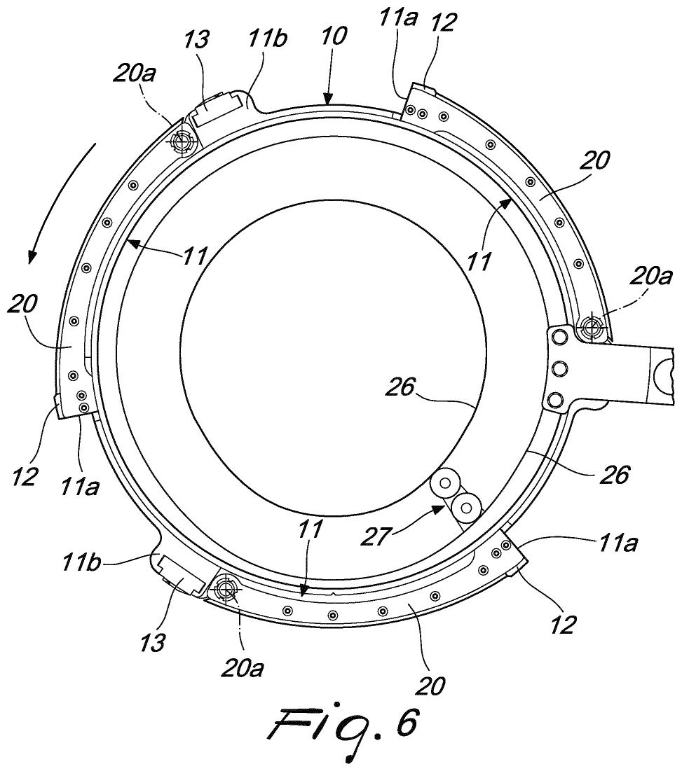

FIG. 6 is a schematic plan view from above of the transfer drum of the machine according to the present invention with a part omitted to show the inside thereof.

With reference to the figures, the labeling machine for applying labels to reusable containers according to the invention, generally designated by the reference numeral 1, comprises a conveyor 2 that makes it possible to move the containers 3 to be labeled along an advancement path 2a.

In particular, the containers 3 are reusable, in that they are adapted, after the product contained in them has been consumed, to be collected and, once stripped of the label affixed on it, washed and, therefore, once again made suitable to receive the product, to be refilled again for a new use.

Preferably, the conveyor 2 comprises a rotating carousel 4, which is provided, at its periphery, with a plurality of pans 5, each one of which is adapted to receive in resting contact a respective container 3 and which are, in turn, rotatable, so as to make the individual containers 3 rotate about their corresponding axes.

At least one labeling assembly 6 is arranged along the advancement path 2a of the containers 3, and comprises a cutting roller 7, mounted so that it can rotate about its own axis, which is fed with a label ribbon 8 on which a plurality of labels 9 are printed in succession.

In particular, as is per se known, the cutting roller 7 receives the label ribbon 8 from an unwinding assembly, not shown, which takes the label ribbon 8 from a corresponding spool, also not shown.

Conveniently, the cutting roller 7 is provided at its periphery with at least one blade 7a, which can interact, during the rotation of the cutting roller 7, with a fixed blade 7b which is integral with the frame of the labeling assembly 6, in order to perform the cutting of the label ribbon 8 at the separation region between one label 9 and the next.

On the labeling assembly 6 there is, furthermore, a transfer drum 10, which can rotate about its own axis and is provided, peripherally, with at least one sector 11 that is adapted, in each instance, to receive from the cutting roller 7, on its side surface, a label 9 obtained from cutting the label ribbon 8 and to transfer it, subsequently, to a respective container 3 arriving on the conveyor 2, at a transfer region 6a of the labeling assembly 6.

It should be noted that the transfer drum 10 can be provided with multiple sectors 11 arranged mutually circumferentially spaced apart along the perimeter of the transfer drum.

Each sector 11 is, conveniently, provided, as is per se known, with suction ports, which make it possible to keep the label 9—received from the cutting roller 7—in adherence to its side surface.

In particular, each sector 11 has, substantially at its front end 11a, with respect to the direction of rotation of the transfer drum 10, a leading skid 12 which is adapted to receive in resting contact the leading end 9a of the label transferred to the corresponding sector 11 from the cutting roller 7. Substantially at its rear end 11b, each sector 11 furthermore has a trailing skid 13, which in turn is adapted to receive in resting contact the trailing end 9b of the label 9 transferred to the corresponding sector 11 from the cutting roller 7.

Laterally to the transfer drum 10, between the region in which the transfer drum 10 receives the labels 9 from the cutting roller 7 and the transfer region 6a where the labels 9 are transferred onto the containers 3, there is a glue application roller 14, which makes it possible to apply at least one strip of glue on the trailing end 9b of the label 9 received by each sector 11 of the transfer drum 10, before the trailing end 9b of the same label is taken away from the transfer drum 10 at the transfer region 6a.

It should be noted that the trailing skid 13 of each sector 11 is structured so as to ensure its interaction with the application roller 14 and therefore allow the application of the glue on the trailing end 9b of the label 9 arranged on the corresponding sector 11.

Along the conveyor 2, upstream of the labeling assembly 6, along the direction of advancement of the containers 3, there are, furthermore, spraying means 15 that make it possible to spray with a dissolvable adhesive material at least the region adapted to receive the labels 9 of the containers 3 transiting on the conveyor 2.

The dissolvable adhesive material can be constituted, for example, by water and, in such case, the spraying means 15 are, conveniently, constituted by at least one spraying device which makes it possible to spray water on the outer surface of the containers 3.

It should be noted that, as an alternative, the dissolvable adhesive material can be an adhesive material that is rapidly degradable or volatile, so as to lose adhesiveness, after the label 9 has been applied on the container 3, in order to facilitate the removal of the latter from the container, once the container 3 has been used, so as to enable the convenient reuse thereof.

The (or each) sector 11 of the transfer drum 10 has at least one portion 20 that can move, with respect to the remaining part of the transfer drum 10, between a first working condition, assumed at least when the front end 11a of the corresponding sector 11 passes in front of the glue application roller 14, and a second working condition, assumed at least when the front end 11a of the corresponding sector 11 passes substantially in front of the transfer region 6a.

In particular, in the first working condition of the movable portion 20, the front end 11a of the corresponding sector 11 is arranged in a position that is close to the axis of the transfer drum 10, in order to prevent the application of glue by the application roller 14 on the leading end 9a of the label 9 received from the corresponding sector 11.

By contrast, in the second working condition of the movable portion 20, the front end 11a of the corresponding sector 11 is arranged in a position that is spaced apart from the axis of the transfer drum 10, in order to allow the adhesion of the leading end 9a of the label 9 that is present on the corresponding sector 11 to the corresponding container 3 arriving on the conveyor 2.

Advantageously, the leading skid 12 of each sector 11 is supported by the movable portion 20 of the corresponding sector 11, while the trailing skid 13 is supported by the remaining part of the corresponding sector 11, and therefore is fixed with respect to the transfer drum 10.

In particular, the movable portion 20 of each sector 11 is constituted by at least one circumferential portion of the corresponding sector 11 which comprises the front end 11a of the corresponding sector 11.

Advantageously, there are actuation means 25 which are configured to actuate the transition of the movable portion 20 of each sector 11 of the transfer drum 10 between the first working condition and the second working condition, on the basis of the angular position of the movable portion 20 about the axis of the transfer drum 10, during the rotation of the latter.

Conveniently, as shown in FIG. 6, the actuation means 25 are provided by at least one cam-like profile 26, which is fixed with respect to the labeling assembly 6 and, for each sector 11, by at least one cam follower 27, which slideably engages the cam-like profile 26.

More preferably, there is a pair of mutually opposite cam-like profiles 26 and, advantageously, positioned inside the perimeter of the transfer drum 10.

Conveniently, the cam follower 27 of each sector 11 is constituted, for example, by a pair of wheels, each one of which slideably engages a respective cam-like profile 26, so as to perform the radial excursion movements that depend on the shape of the cam-like profiles 26.

More specifically, the cam follower 27 of each sector 11 is supported by the movable portion 20 of the corresponding sector 11, so that the excursion movements of the cam follower 27 are transmitted to the movable portion 20 of the corresponding sector 11, thus causing the transition between the first and the second working condition.

Advantageously, the movable portion 20 of each sector 11 is mounted rotatably movable, with respect to the remaining part of the transfer drum, about an oscillation axis 20a that is substantially parallel to the axis of the transfer drum 10 and is arranged substantially at a region of the corresponding sector 11 that is proximate to the corresponding trailing skid 13.

In more detail, the movable portion 20 of each sector 11 is pivoted, at one of its ends, to the rest of the transfer drum 10, about the oscillation axis 20a, and supports, at its other end, which corresponds to the front end of the corresponding sector 11, the leading skid 12 of the corresponding sector 11.

In practice, the movable portion 20 of each sector 11 substantially constitutes the circumferential portion of the corresponding sector 11 that extends from a point of the corresponding sector 11 located directly upstream of the trailing skid 13, with respect to the direction of rotation of the transfer drum 10, where it is pivoted to the rest of the transfer drum 10, up to the front end 11a of the corresponding sector 11.

With this structure, the movable portion 20 of each sector 11 can tilt about the oscillation axis 20a and is able therefore to assume at least two different angular positions, with respect to its oscillation axis 20a, and, more specifically, a first angular position, which corresponds to the first working condition of the movable portion 20, wherein the movable portion 20 is arranged so that the front end 11a and, therefore, the leading skid 12 of the corresponding sector 11 are close to the axis of the transfer drum 10, and a second angular position, which corresponds to the second working condition of the movable portion 20, wherein the movable portion 20 is arranged so that the front end 11a and, therefore, the leading skid 12 of the corresponding sector 11 are spaced apart from the axis of the transfer drum 10.

The operation of the machine according to the present invention is the following.

The containers 3 to be labeled are made advance by the conveyor 2 along the advancement path 2a.

Before their arrival at the labeling assembly, the spraying means 15 spray a dissolvable adhesive material on at least the region of the containers 3 that is adapted to receive the labels.

In the meantime, the label ribbon 8 is fed to the cutting roller 7, which, rotating about its own axis, enables each one of the blades 7a to cooperate with the fixed blade 7b, so as to cut in each instance a label 9 from the label ribbon 8, while a sector 11 of the transfer drum 10 moves progressively closer to the region of the cutting drum 7 with the corresponding movable portion 20 in the first working condition.

The label 9 obtained after cutting is then fed by the cutting roller 7 to the transfer drum 10 which moves in rotation about its own axis so as to receive the leading end 9a of the label 9 at the leading skid 12 of the sector 11 which has reached the cutting roller 7 with its movable portion 20 still in the first working condition, as shown in FIG. 2.

As the cutting roller 7 and the transfer drum 10 continue in their rotation, the label 9 received by the sector 11 is arranged therefore with its trailing end 9b resting on the trailing skid 13 of the sector 11.

At this point, the leading end 9a of the label 9 received by the sector 11 is brought to the glue application roller 14.

In this step, the movable portion 20 of the sector 11 that received the label 9 remains in the first working condition, so that the front end 11a of the sector 11 and the corresponding leading skid 12 are close to the axis of the transfer drum 10 and as a consequence the leading end 9a of the label 9 does not come into contact with the application roller 14, so as not to receive the glue from the application roller 14.

Continuing the rotation of the transfer drum 10, the trailing skid 13 of the sector 11 that received the label 9 also arrives at the application roller 14 and interacts with the application roller 14 so as to obtain the application of a strip of glue on the trailing end 9b of the label 9.

Once the front end 11a of the sector 11 has passed the application roller 14, preferably after the rear skid 13 of the sector 11 has also passed the application roller 14, the actuation means 25 bring the movable portion 20 of the sector 11 to the second working condition.

More specifically, the movable portion 20 of the sector 11 is made to rotate about its own oscillation axis 20a, by virtue of the corresponding cam follower 27 rolling on the cam-like profile 26, so that the front end 11a of the sector 11 and, therefore, the leading skid 12 of that sector are brought to a position spaced apart from the axis of the transfer drum 10.

With the movable portion 20 in the second working condition, the front end 11a of the sector 11 therefore arrives at the transfer region 6a of the labeling assembly 6, so that the leading skid 12 of the sector 11, which is in the position spaced apart from the axis of the transfer drum 10, can interact with a corresponding container 3 arriving on the conveyor 2.

The presence of the dissolvable adhesive material on the outer surface of the container 3 ensures that the leading end 9a of the label 9 resting on the leading skid 12 of the sector 11 adheres to the container 3 which, because it is rotated about its own axis by the corresponding pan, wraps the label 9 around it, while it continues in its movement along the advancement path 2a.

Once the leading skid 12 of the sector 11 has passed the transfer region 6a, thus exiting from the interaction with the container 3, the movable portion 20 of the sector is returned by the actuation means 25 to the first working condition and, more specifically, the movable portion 20 is made to rotate in the direction opposite to the previous direction, so as to return the front end 11a of the sector 11 and therefore also the leading skid 12 of that sector to the position close to the axis of the transfer drum 10.

When the trailing skid 13 of the sector 11 also arrives at the transfer region 6a, the trailing end 9b of the label 9 is pressed by the trailing skid 13 against the container 3 on which the label 9 has been wound, so as to make the trailing end 9b of the label 9 adhere, by way of the glue applied by the application roller 14, to top of the leading end 9a of that label.

At this point the container 3 thus labeled continues its movement along the advancement path on the conveyor 2 and, with the continuing rotation of the transfer drum 10, the sector 11 that transferred the label to the container 3 is brought to face the cutting roller 7 once again so that it can receive a new label 9.

In practice it has been found that the invention fully achieves the intended aim and objects and, in particular, attention is drawn to the fact that, thanks to the presence of a movable portion of the sectors of the transfer drum, it is possible to ensure a correct application of the labels by way of the dissolvable adhesive material.

It should be noted that, by virtue of the presence of the movable portion at each sector of the transfer drum, firstly it is possible to reduce, with respect to the known art, the misalignment of the profile of the sector with respect to the profile that the sector would have if the transfer drum were cylindrical and, secondly, it is possible to reduce, with respect to the known art, the offset between the front portion of the labels transferred to the transfer drum and the front skid of the sectors, during the transfer of the labels from the cutting roller to the transfer drum, thus eliminating or at least considerably limiting the presence of bulges on the labels that could compromise the operation of the machine.

The invention, thus conceived, is susceptible of numerous modifications and variations, all of which are within the scope of the appended claims.

In this regard, it must be noted that the progression of the outer surface of each sector 11 can be configured so that, with the movable portion 20 in the first working condition, the outer surface of each sector 11 is misaligned, although to a lesser extent with respect to the known art, with respect to the hypothetical progression that it would have if the transfer drum were made with the typical cylindrical shape.

Lastly it should be noted, for completeness, that it is possible to use a cylindrical drum i.e. it is possible to make each sector of the transfer drum so that the misalignment of its profile with respect to a cylindrical transfer drum is nil. In this case, the contact between the sectors of the transfer drum and the containers would be avoided exclusively with the movement of the movable portion of the sectors, but this would cause, for certain geometries and at high speeds, an excessive movement of the sectors with consequent breakdown of the position of the label on the corresponding sector, again compromising the operation of the machine. In other words, the interaction between the transfer drum and the containers can be controlled via the geometry of the transfer drum (misalignment of the sectors) or via the movement of the movable portions, but the correct operation of the machine is favored by a trade-off solution.

Moreover, all the details may be substituted by other, technically equivalent elements.

In practice, the materials used, as well as the contingent shapes and dimensions, may be any according to the requirements and to the state of the art.

The disclosures in Italian Patent Application No. 102022000019500 from which this application claims priority are incorporated herein by reference.

Where technical features mentioned in any claim are followed by reference signs, such reference signs have been inserted for the sole purpose of increasing the intelligibility of the claims and accordingly such reference signs do not have any limiting effect on the interpretation of each element identified by way of example by such reference signs.

1-6. (canceled)

7. A labeling machine for applying labels to reusable containers, which comprises a conveyor for conveying containers to be labeled along an advancement path and at least one labeling assembly arranged along said advancement path, said at least one labeling assembly comprising a cutting roller fed with a label ribbon and a transfer drum, which can rotate about an axis thereof and is provided peripherally with at least one sector that is adapted, in each instance, to receive from said cutting roller, on a lateral surface thereof, a label obtained from the cutting of said label ribbon and to transfer the label to a respective container arriving on said conveyor, at a transfer region of said labeling assembly, said at least one sector having, substantially at a front end thereof with respect to a direction of rotation of said transfer drum, a leading skid which is adapted to receive in resting contact a leading end of the label transferred to the corresponding sector by said cutting roller and, substantially at a rear end thereof, a trailing skid which is adapted to receive in resting contact a trailing end of the label transferred to the corresponding sector by said cutting roller, laterally to said transfer drum there being a glue application roller for applying glue to the trailing end of the label received from said at least one sector; along said conveyor, upstream of said at least one labeling assembly along an advancement direction of the containers, there being spraying means for spraying a dissolvable adhesive material at least on a region of the containers which are transiting on said conveyor that is adapted to receive the labels, wherein said at least one sector has at least one movable portion which is configured to move, with respect to a remaining part of said transfer drum, between a first working condition, assumed at least when a front end of said at least one sector passes in front of said glue application roller, wherein the front end of said at least one sector is arranged in a position that is close to the axis of said transfer drum, in order to prevent application of glue by said glue application roller to the leading end of the label received from said at least one sector, and a second working condition, assumed at least when the front end of said at least one sector passes substantially in front of said transfer region, wherein the front end of said at least one sector is arranged in a position that is spaced apart from the axis of said transfer drum, in order to allow adhesion of the leading end of the label received from said at least one sector to the corresponding container.

8. The machine according to claim 7, wherein said leading skid is supported by said movable portion of said at least one sector.

9. The machine according to claim 7, further comprising actuation means which are configured to perform a transition of said movable portion of said at least one sector between said first working condition and said second working condition, as a function of an angular position of said movable portion about the axis of said transfer drum.

10. The machine according to claim 9, wherein said actuation means comprise at least one cam-like profile, which is fixed with respect to said labeling assembly and is slideably engaged by at least one cam follower supported by said movable portion.

11. The machine according to claim 7, wherein said movable portion of said at least one sector is rotatably movable, with respect to the remaining part of said transfer drum, about an oscillation axis that is substantially parallel to the axis of said transfer drum and is arranged substantially at a region of said at least one sector that is proximate to the corresponding trailing skid.

12. A method for labeling containers, which comprises the steps of:
advancing, along an advancement path, containers to be labeled;
spraying a dissolvable adhesive material at least on a region of the containers that is adapted to receive the labels;
cutting a label ribbon in order to obtain labels to be applied to the containers;
feeding the labels to a transfer drum thus placing each label on a respective sector of said transfer drum;
rotationally moving said transfer drum about an axis thereof in order to make the labels fed to said transfer drum pass in front of a glue application roller, so as to apply the glue to a trailing end of the labels, and in order to subsequently move a leading end of the labels fed to said transfer drum so that the leading end adheres to the respective containers by means of said dissolvable adhesive material at a transfer region of said labeling assembly,
further comprising the steps of positioning a movable portion of each sector in a first working condition, prior to a passing of the corresponding sector in front of said glue application roller, in order to arrange a front end of the corresponding sector in a position that is close to the axis of the transfer drum, in order to prevent application of glue by said glue application roller to the leading end of the label received from the corresponding sector, and of positioning said movable portion of each sector in a second working condition, prior to the arrival of the corresponding sector at said transfer region, in order to arrange a front end of the corresponding sector in a position that is spaced apart from the axis of said transfer drum, in order to allow adhesion of the leading end of the label received from the corresponding sector to the corresponding container.
